(19) United States
(12) Patent Application Publication
(10) Pub. No.: US 2008/0094817 A1
(43) Pub. Date: Apr. 24, 2008

(54) Educational lighting kit

(76) Inventors: Thomas A. Waltz, Manitou Beach, MI (US); Kelly Mondora, Perrysburg, OH (US)

Correspondence Address: EMCH, SCHAFFER, SCHAUB & PORCELLO CO, P O BOX 916, ONE SEAGATE SUITE 1980, TOLEDO, OH, 43697, US

(21) Appl. No.: 11/973,459

(22) Filed: Oct. 9, 2007

Related U.S. Application Data
(60) Provisional application No. 60/850,884, filed on Oct. 10, 2006.

(51) Int. Cl. G03B 15/02

(52) U.S. Cl. 362/3; 434/430

(57) ABSTRACT

An educational lighting kit to enhance the quality of the image captured of a subject utilizing a floor mat having specific indicators located around the floor mat. The indicators identifying the desired location for specific components selected from the group of lights, light modifiers, reflectors, backgrounds, cameras and image capture equipment. The floor mat also includes an indicator for the subject for the image capture.

### CROSS REFERENCE TO RELATED APPLICATIONS

This application claims the benefit of U.S. provisional patent application Ser. no. 60/850,884, filed Oct. 10, 2006.

### FIELD OF INVENTION

This invention relates to an educational lighting kit designed for a consumer or professional imagemaker. More specifically, the educational lighting kit provides a floor positioning mat incorporating specific positioning points for a light(s), camera(s), subject(s), background(s) as well as other photographic accessories. Each specific positioning point has been pre-determined for consistent and accurate results.

### BACKGROUND OF THE INVENTION

Consumers and professional imagemakers look to achieve quality lighting when conducting image capture. Quality lighting will help enhance the look of the subject(s) thus enhancing the final image captured. It is difficult for one not skilled within the trade of image capture to achieve quality lighting due to the experience needed to determine correct placement of numerous photographic lighting tools.

The educational lighting kit allows the consumer or professional imagemaker to quickly and accurately light their subject(s). This correct placement of photographic lighting tools is achieved through the pre-determined floor-positioning mat.

### SUMMARY OF THE INVENTION

The present invention relates to an educational light kit consisting of a light(s), background(s), floor-positioning mat(s), light modifier(s), light stand(s), and carry case.

The light provides illumination onto the subject(s). The light may be in the form of a constant light or strobe light, utilizing a flash tube(s), using a variety of lamps that offer varying degrees of color temperature and light output.

The background is constructed of a soft texture fabric and either hand printed, screen-printed or digitally printed with an image or pattern. Utilizing a background results in a professional look for the consumer or professional imagemaker.

The floor-positioning mat is constructed of a soft texture fabric and can be made of paper, plastic, vinyl or other suitable materials. The mat incorporates specific positioning points for a light(s), camera(s), subject(s), background(s) as well as other photographic accessories. Each specific positioning point has been pre-determined for achieving consistent and accurate lighting results. With these pre-determined positioning points, an imagemaker posses the knowledge to achieving quality lighting and image capture.

The light modifier is designed to provide various types of controlled light for the imagemakers. This controlled light from the light modifier will soften the luminosity emitted from the light source. The light modifier works in conjunction with the light source to produce a pleasing lighting effect on the subject(s) prior to image capture.

Light stands come in varying sizes and shapes and offer a support for the light and light modifier to be inserted onto. The light stand allows the consumer or imagemaker to raise or lower the light and light modifier based on the instruction given with the floor-positioning mat.

The carry case offers the educational lighting kit to be quickly stored and/or transported.

Other objects and advantages of the present invention will become apparent of those skilled in the art upon a review of the following detailed description of the preferred embodiments and the accompanying drawings.

### BRIEF DESCRIPTION OF THE DRAWINGS

FIG. 1 is a top view of the floor-positioning mat according to the present invention.

FIG. 2. is a top view of the educational light kit containing lights, light modifiers, a background, and floor-positioning mat located in the desired positions.

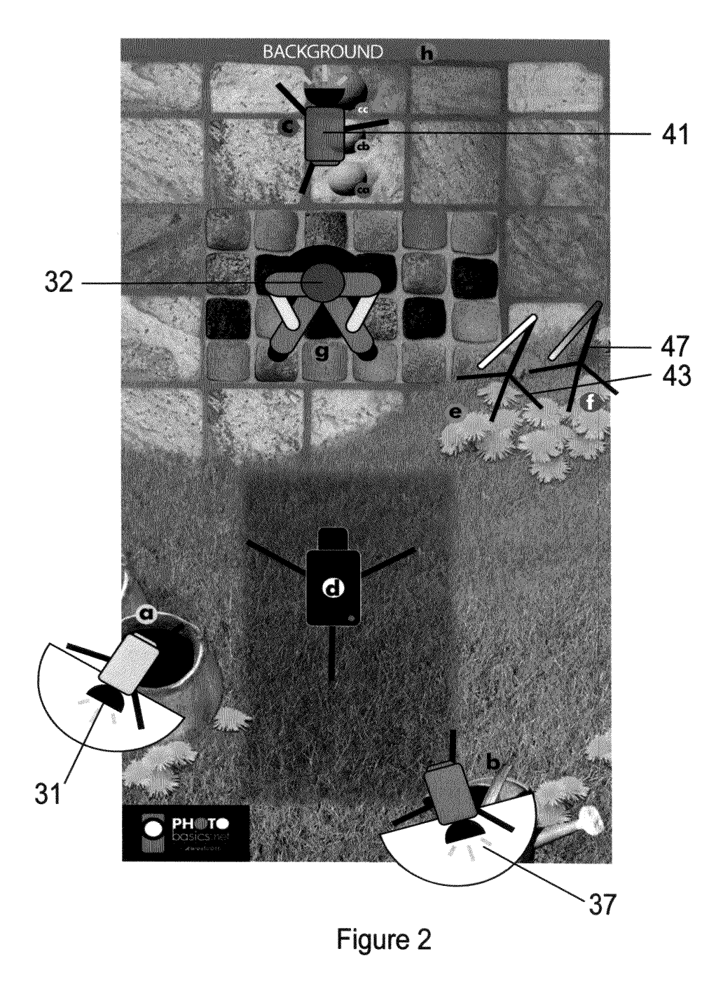

FIG. 3 is a side view of a light and light modifier contained within the educational light kit.

FIG. 4 is a side view of a light and light modifier contained within the educational light kit.

FIG. 5 is a side view of a light and light modifier contained within the educational light kit.

FIG. 6 is a side view of a photographic accessory referred to commonly in the art of image capture as a reflector using a highly reflective colored surface.

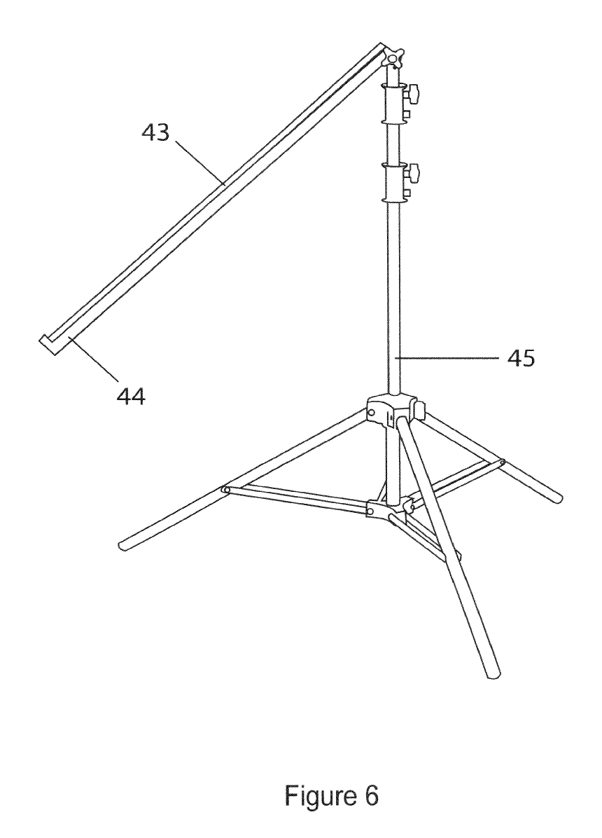

FIG. 7 is a side view of a photographic accessory referred to commonly in the art of image capture as a reflector using a very dull white or neutral colored surface.

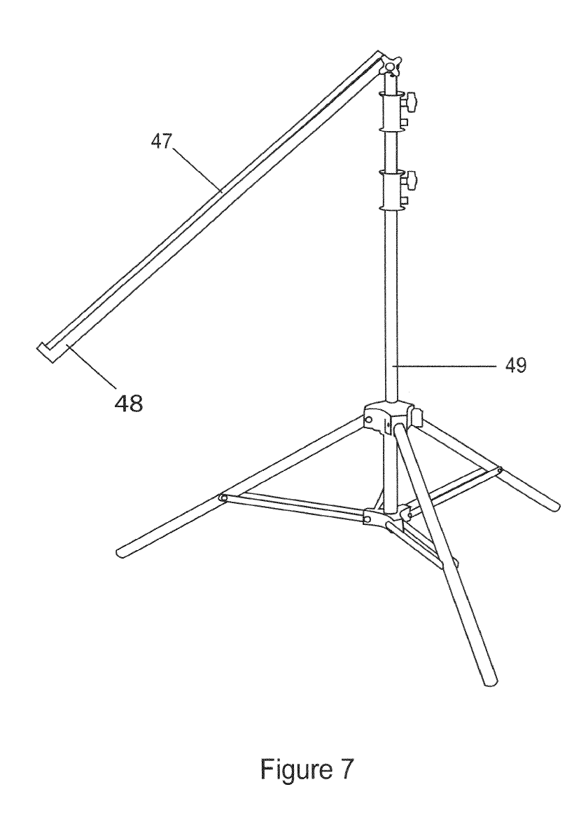

FIG. 8 is a side view of the carry case containing the educational light kit.

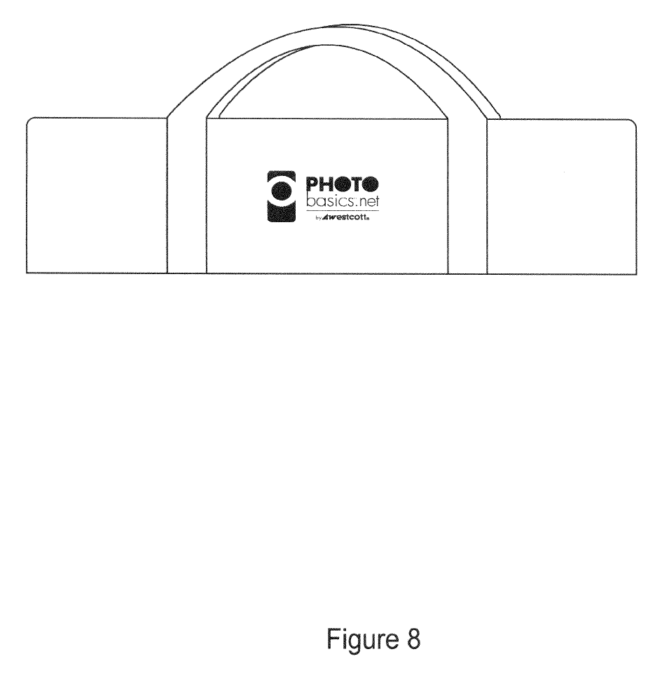

### DETAILED DESCRIPTION OF THE PREFERRED EMBODIMENT(S)

The assembly of components provided with this invention is an economical and educational light kit that is ideal for a consumer or professional imagemaker shooting with film, video, or digital image capture equipment. The assembly offers quick and accurate positioning of multiple lighting tools along with instruction to insure quality lighting that can be quickly assembled for image capture. Image capture of this quality normally could not be obtained by anyone not skilled within the trade. The educational light kit consists of a light(s), background(s), floor-positioning mat(s), light modifier(s), light stand(s), and carry case. The light provides illumination onto the subject(s). The light may be in the form of a constant light or strobe light, utilizing a flash tube(s), using a variety of lamps that offer varying degrees of color temperature and light output. The background is constructed of a soft texture fabric and either hand printed, screen-printed or digitally printed with an image or pattern. Utilizing a background results in a professional look for the consumer or professional imagemaker. The floor-positioning mat is constructed of a soft texture fabric and can be made of paper, plastic, vinyl or other suitable materials. The mat incorporates specific positioning points for a light(s), camera(s), subject(s), background(s) as well as other photographic accessories. Each specific positioning point has been pre-determined for achieving consistent and accurate lighting results. With these pre-determined positioning points, an imagemaker posses the knowledge to achieving quality lighting and image capture. The light modifier is designed to provide various types of controlled light for the imagemakers. This controlled light from the light modifier will soften the luminosity emitted from the light source. The light modifier works in conjunction with the light source to produce a pleasing lighting effect on the subject(s) prior to image capture. Light stands come in varying sizes and shapes and offer a support for the light and light modifier to be inserted onto. The light stand allows the consumer or imagemaker to raise or lower the light and light modifier based on the instruction given with the floor-positioning mat.

The assembly offers the consumer or photographic imagemaker a tool to achieve quality lighting at an economical price and requires no prior education within the trade.

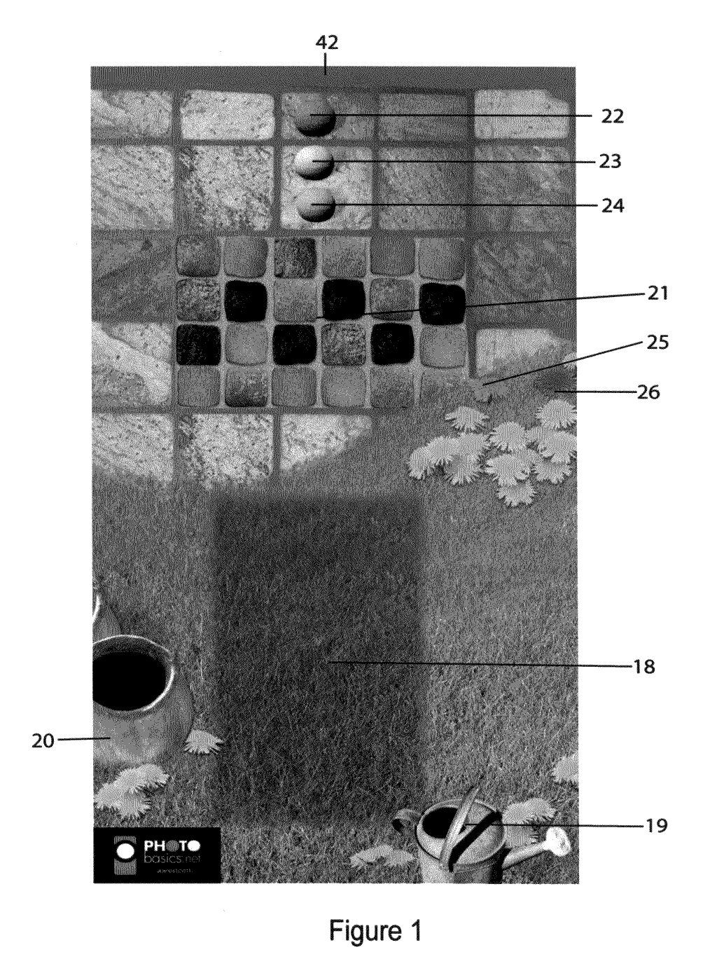

FIG. 1 is a top view of the floor-positioning mat according to the present invention. The floor mat has specific indicators located around the floor mat that identify the desired location for specific components such as lights, light modifiers, reflectors, backgrounds, the subject and the device capturing the image. The shaded grassy area 18 designates where the consumer or imagemaker would place their film or digital camera equipment. The smile tile pattern 21 designates where your subject(s) will be placed for image capture.

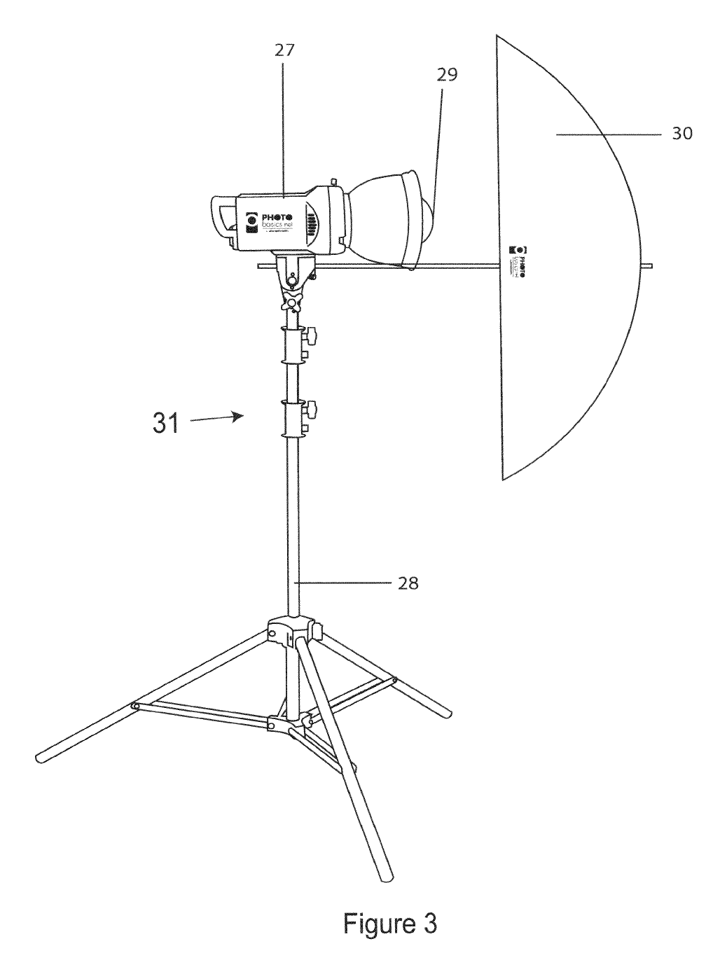

The clay pot 20 designates the placement of the first light 27. The light 27 will be mounted on top of a light stand 28 with the lamp 29 positioned to direct light in a direction away from the tile 21. A light modifier 30 is then mounted onto the light 27. The light modifier 30 reflects and modifies the light produced from the lamp 29 in a manner known in the professional image capture industry. This completed light assembly 31 will then be placed on top of the clay pot 20. The imagemaker then positions the light assembly shown in FIG. 3 approximately one-foot higher than the subject(s) 32 tallest point. The light modifier 30 is then pointed so that the light is directed at the subject(s) 32. The light assembly 31 will act as a main light or illuminator for the subject(s) 32.

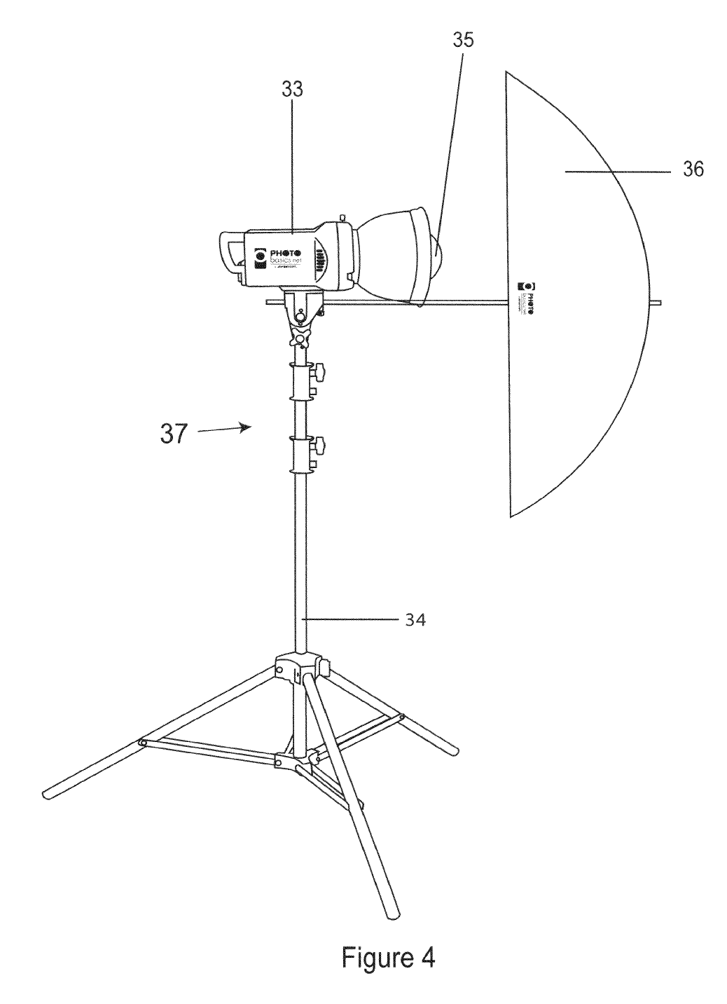

The watering can 19 designates the desired placement of the second light 33. The light 33 will be mounted on top of a light stand 34 with the lamp 35 positioned to direct light in a direction away from the tile 21. A light modifier 36 is then mounted onto the light 33. The light modifier 36 reflects and modifies the light produced from the lamp 29 in a manner known in the professional image capture industry. This completed assembly as shown in FIG. 4 is then placed on top of the watering can 19. The imagemaker then positions the light assembly shown in FIG. 4 at the same height as their film, video or digital camera equipment located in grassy area 18. The light modifier 36 is then pointed so that the light is directed at the subject(s) 32. The light assembly 37 will act as a fill light that fills in shadows while illuminating the subject(s) 32.

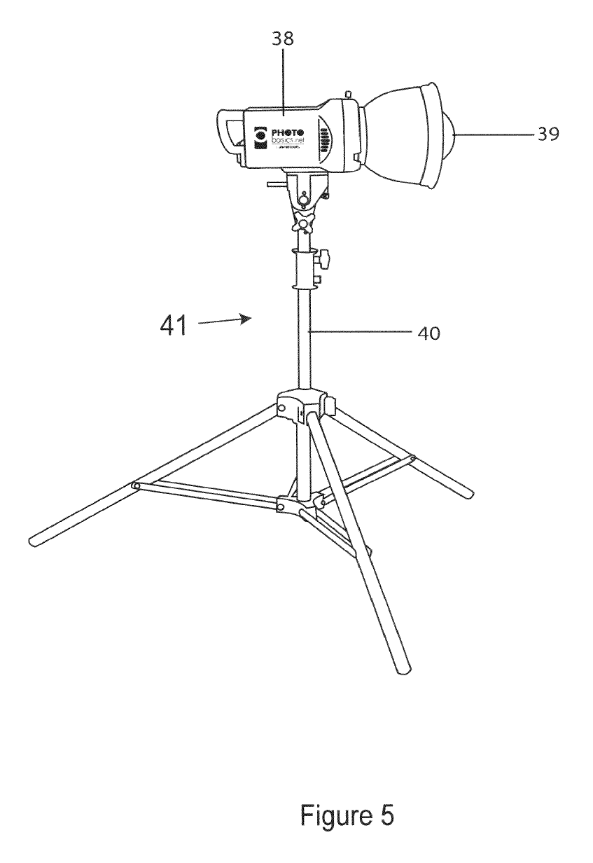

The circular stones 22, 23 and 24 designate the placement of a third light 38. The third light 38 is a background light. The third light 38 is used to illuminate a background 42 and helps to separate the subject(s) 21 from the background 42. The light 38 is mounted on top of a light stand 40 with the lamp 39 positioned to direct light in a direction away from the tile 21 and towards the background 42. This completed assembly 41, as shown in FIG. 5, is then placed on top of the circular stone 22 when conducting an image capture with one subject. When conducting an image capture with two subjects the light assembly 41 is placed directly over the circular stone 23. When conducting image capture with three or more subjects, the light assembly 41 is placed directly over the circular stone 24. The imagemaker points the light assembly 41 directly towards the background 42 until the light assembly illuminates a circle of light onto the background 42 that is centered directly behind the subject(s) 32.

The orange flower 25 is used to locate an optional white or neutral reflector panel 43. The reflector panel 43 is attached to a reflector arm 44. The reflector arm 44 allows the reflector panel 43 to be tilted in various positions to further control light reflection. The reflector arm 44 and reflector panel 43 are then attached to a light stand 45. This reflector panel 43 is then positioned towards the subject(s) 32 to fill in shadow areas or to add color to the subject(s) 32.

The purple flower 26 is used to locate an optional highly reflective gold or silver reflector panel 47. The reflector panel 47 is attached to a reflector arm 48. The reflector arm 48 allows the reflector panel 47 to be tilted in various positions to further control light reflection. The reflector arm 48 and reflector panel 47 are attached to a light stand 49. The reflector panel 47 is then positioned towards the subject(s) 32 to fill in shadow areas or to add color to the subject(s) 32.

The assembly of this invention creates the ability for a user to produce quality lighting using up to four light sources and accessories in a proper manner and location through the use of the floor-positioning mat.

While certain embodiments of the invention have been described for purposes of illustration, it is to be understood that there may be various embodiments and modifications, other than those cited, that can be used without departing from the general scope of the invention as defined by the following claims.

We claim:

1. An educational lighting kit to enhance the quality of the image captured of a subject comprising:
a floor mat having specific indicators located around the floor mat, the indicators identifying the desired location for specific components selected from the group of lights, light modifiers, reflectors, backgrounds and image capture equipment, the floor mat also including an indicator for the subject for the image capture.

2. The kit of claim 1 wherein a first light is provided for positioning on the floor mat on the indicator for locating the first light.

3. The kit of claim 2 wherein a light modifier is provided for positioning on the first light wherein modified light from the first light is used to illuminate the subject.

4. The kit of claim 1 wherein a second light is provided for positioning on the floor mat on the indicator for locating the second light.

5. The kit of claim 4 wherein a light modifier is provided for positioning on the second light wherein modified light from the second light is used to illuminate the subject.

6. The kit of claim 1 wherein a background is positioned adjacent the floor mat, the background is disposed to be behind the subject.

7. The kit of claim 6 wherein a third light is provided for positioning on the floor mat on the indicator for locating the third light, the third light is disposed to direct illumination on the background.

8. The kit of claim 1 wherein at least one reflector panel is provided for positioning on the floor mat on an indicator for locating a reflector panel.

9. The kit of claim 1 wherein a camera is provided for positioning on the floor mat on the indicator for locating the camera.
